(19) United States
(12) Patent Application Publication
(10) Pub. No.: US 2011/0191460 A1
(43) Pub. Date: Aug. 4, 2011

(54) System and a Method Relating to Network Management

(76) Inventors: Francoise Sailhan, Paris (FR); Sandra Collins, Dublin (IE); Samir Ghamri-Doudane, Paris (FR); Liam Fallon, Athlone (IE); Yang Cheng Huang, London (GB); Daryl Parker, Athlone (IE)

(21) Appl. No.: 12/514,582

(22) PCT Filed: Nov. 14, 2006
(86) PCT No.: PCT/EP2006/068448

§ 371 Date: Mar. 8, 2011

(51) Int. Cl. G06F 15/173; H04L 12/24

(52) U.S. Cl. 709/224; 709/223

(57) ABSTRACT

The present invention relates to a node supporting networking and communication with other nodes by means of a layered communication protocol and group communication with other nodes controlled via a grouping protocol adapted to interact with said communication protocol. The node comprises a policy engine which is arranged separately from, but in communication with said grouping protocol. The policy engine is adapted to establish current and/or changing node, group and network related information and to use one or more grouping policies to automatically and dynamically control grouping related actions and adapt the grouping. The invention also relates to a system comprising a number of such nodes and a method of controlling grouping.

### TECHNICAL FIELD

The present invention relates to networks supporting group communication and group management. It particularly relates to a node, a system and a method for group management.

### BACKGROUND

Network management is becoming a more and more challenging issue due to the fact that networks become more and more complex, they grow in a forseeable way as well as in unforseeable ways, evolve continuously and require interoperability with other networks. An increasingly complex and heterogeneous network environment is also expected due to the emergence of an enormous amount of new, complex and advanced services. Different standards are implemented, management and billing service provisioning should be provided in a satisfactory manner both for customers, network operators and management staff. Over the last years, group communication has become an interesting issue. Numerous grouping strategies targeting distinct applications and designed to operate in specific networks have been proposed. A plurality of grouping protocols are known, such as for example the traditional token-ring protocols, multicast protocols and application-level and overlay-based grouping protocols.

By means of token ring protocols, a ring-based topology is created which is used to pass a token around the group members for e.g. controlling access to a given resource. Such protocols typically target small size networks. So called multicast protocols, on the other hand, focus on large scale networks. IP (Internet Protocol) multicast allows data to be sent to multiple receivers independently of their localization. The sources only need to know a multicast address and do not process any membership related information. As a consequence thereof, it becomes possible for members to join or leave a group easily since there is no need to register with a centralised group management entity. However, IP multicast has not been deployed to a very large extent both for technical reasons, such as complex billing, management and security concerns, but also for non-technical reasons. Therefore application-level based on overlay-based protocols have been suggested which have been more popular. Application-level grouping is for example discussed in “Void: Your Own Internet Distribution”, Paul Francis et al., http://www.isi.edu/div7/yoid/, and the NICE protocol “Scalable Application Layer Multicast” S. Banerjee, B. Bhattacharjee, C. Kommareddy, Proceedings of ACM Sigcomm 2002, Pittsburgh, Pa., August 2002. It is based on end hosts implementing group-related functionalities such as membership management. The underlying physical topology is hidden and a virtual graph is created between all the nodes. The overlay based approaches are for example described in “Scribe: A large scale and decentralized application-level multicast infrastructure” by M. Castro, et al. in IEEE Journal on selected areas in communications, Vol. 20, No 8, 2002.

Such overlay based approaches first build a DHT-based overlay assigning some coordinate or identity to each member so as to create a well connected virtual network, corresponding to an overlay network, on top of which a group is created.

The fact that grouping management is a fundamental concept in computer science, has had as an effect that a large variety of protocols have been developed, each creating different grouping topologies adapted to application requirements, for example bandwidth availability for real-time video delivery or video conference. However, a group management strategy, which includes a membership strategy and a group structure management strategy, raises a number of issues which cannot be satisfactorily handled by the current grouping protocols. Indeed, it typically requires human intervention to set up complex network element grouping in a large-scale network. The routing protocol OSPF (Open Shortest Path First), cf. OSPF version 2, IETF RFC (Request for Comments) 1247, www.ietf.org., July 1991 by J. Moy, requires the definition of separate areas in which traffic induced by flooding of link state information can be confined. However, this area definition still has to be performed statically by a network administrator. In addition thereto, grouping protocols only verify one or a limited set of constraints, and use one or a limited set of metrics to guarantee their performances. For example, a metric can impact on the structure of the group, elements can be grouped in an ordered way according to their bandwidth, or their distance (geographical or number of hops). Constraints may relate to the maximum number of elements that are grouped, minimum capacity required to group the network elements, for example processing power, memory, storage space, or the role of the network elements, (for example Radio Base Stations (RBS) or Radio Network Controllers (RNC) or any other nodes or network elements). This simplicity of the grouping protocols remains a major obstacle for configuring and managing dynamically sets of networked resources and network elements that are heterogeneous in nature, complex to manage, and dynamically evolved.

Thus, so far no satisfactory way of providing for grouping or grouping management has been provided.

### SUMMARY

It is an object of the present invention to provide means for network management implementing grouping. It is also an object of the invention to provide a solution that enables efficient implementation of group communications and group management, and particularly to provide a solution which enables automation of network management as well as increased performance thereof. Still further is an object of the invention to provide a solution as far as network management is concerned through which operation and maintenance traffic can be reduced and through which network management efficiency in general can be increased. Particularly it is an object of the invention to provide a node through which on or more of the above mentioned objects can be achieved, as well as a system and a method respectively, through which one or more of the above mentioned objects can be achieved.

Therefore the present invention suggests a node supporting networking and communication with other nodes by means of a layered communication protocol comprising a communication layer and which further supports group communication with other nodes controlled via a grouping protocol which is adapted to interact with said communication layer. According to the invention the node comprises a policy engine which is arranged separately from, but in communication with, said communication protocol. The policy engine is adapted to establish current and/or changing node, group and network related information and provide or activate one or more grouping policies and to, using said policies and said information, dynamically and automatically control grouping related actions and adapt the grouping.

The invention also suggests a data or telecommunications network comprising a number of nodes having the features described above.

In order to solve one or more of the problems discussed above, i.e. to fulfil one or more of the objects referred to above, the invention also suggests a method of controlling grouping of nodes supporting communication and networking with other nodes by means of a layered communication protocol comprising a communication layer, and a grouping protocol. According to the invention the method comprises the steps of; providing or activating one or more grouping related policies to be used for grouping of nodes; monitoring or establishing updated, current (or changing) node, group and network related information; using said information and grouping policy or policies to control grouping related actions dynamically and automatically and to adapt the grouping.

It is an advantage of the invention that self-grouping of network elements or nodes can be provided. Generally it is an advantage that network management performance can be increased and made more efficient and that operation and maintenance related traffic significantly can be reduced. Still further it is an advantage that human interaction or involvement can be reduced at the same time as network management efficiency can be increased. It is also an advantage that network management, e.g. operation and maintenance, can be facilitated and improved also for evolving and changing network structures. A particular advantage lies in that it becomes possible to integrate and manage several heterogeneous environments, different network operators and network vendors. A positive aspect is also that in several ways network management can be automated more or less independently of network size and complexity. A particularity of the invention is that the need for human intervention and financial costs associated therewith are reduced. This is achieved through automation of configuration and management upon a grouping structure which is adapted to the requirements driven by the specific configuration and management tasks that need to be achieved. It is also particularly an advantage that it becomes possible to timely, in a managed and controlled way, handle the grouping while eliminating human errors and omissions etc. An important advantage is also that adaption to new requirements or changes of behaviour can be handled without requiring and re-implementation of grouping protocols (which is time-consuming costly and involves a risk of introducing errors into the system).

### BRIEF DESCRIPTION OF THE DRAWINGS

The invention will in the following be more thoroughly described, in a non-limiting way, and with reference to the accompanying drawings, in which:

FIG. 1 schematically illustrates a node in which the inventive concept is implemented.

FIG. 2 is a simplified overview of a network comprising a number of nodes with indication of a current group,

FIG. 3 is a more detailed illustration of a node according to one embodiment of the invention,

FIG. 4 schematically illustrates another embodiment of a node according to the invention,

FIG. 5 is a schematical flow diagram describing in general terms one example of the inventive procedure,

FIG. 6 is a more detailed flow diagram describing an implementation of the inventive procedure,

FIG. 7A is a flow diagram describing policy adapting by means of a graphical interface, and

FIG. 7B is a flow diagram describing reception of a policy update.

### DETAILED DESCRIPTION

According to the present invention policies are used for the purpose of grouping nodes or network elements. Through a policy-based grouping according to the present invention, a plurality of nodes or network elements, for example computers, base stations, routers or resources are enabled to form a self-organizing and adaptive group or groups for the purpose of their configuration and management. The group formation particularly takes place automatically in so far that no or only a minimum of human involvement or interaction is required. According to the inventive concept, nodes or managed network elements particularly are provided with the capability of explicitly controlling their grouping. For this purpose policies are enacted which serve as general guidelines to restrict and define both the behaviour of the group members and the metrics used to create and adapt the group structure according to the current situational context (the network context) and according to the configuration and management tasks that have to be performed.

In a particular embodiment the node comprises a policy engine which comprises monitoring means adapted to collect current and/or change related information concerning status and/or activity or nodes, groups and network and further being adapted to provide said information to a policy decision means. Policy handling means may also be provided which are adapted to indicate and/or activate one or more grouping policies to be used in the node grouping and to provide information about said one or more grouping policies to the policy decision means. The policy decision means are then adapted to interpret said active grouping policies and to make grouping related policy decisions based on said interpretations. The policy engine preferably also comprises policy enforcement means which are adapted to enforce said decisions.

In an advantageous implementation said policy enforcing means are adapted to enforce said decisions using the grouping protocol interacting with the communication layer of the communication protocol. The policy handling means may particularly comprise a policy management tool with a user interface. This enables a network administrator or some management operator to activate, select or indicate policies to be used for grouping purposes. The policy handling means may also, or additionally, comprise or communicate with policy holding means for holding grouping policies. In one embodiment the policy holding means are provided locally on the node. They may also be associated with the node, or associated with some nodes.

In a particular implementation the policy decision means are adapted to control a grouping related decision process, which may relate to one or more of group membership of nodes, group structure, group or group member constraints and metrics. This decision process may for example be used to answer to specific objectives of network configuration management tasks or applications which are provided by a configuration and management application.

The grouping protocol preferably comprises a group management protocol providing messaging capabilities required for group controlling and node group member communication.

Advantageously the policy enforcement means are adapted to control, for example by giving orders to, the grouping protocol, wherein said orders correspond to the decisions made in the decision means.

In a preferred, but optional, implementation, the policy decision means comprises a policy conflict resolution function which is adapted to detect conflicts between policy rules of different active policies and to resolve the conflicts either automatically or by means of invoking (to some extent) manual or operator intervention.

The grouping policies are particularly defined as sets of policy rules. Particularly the node is adapted to comprise or communicate with configuration and management applications, and the policy engine is particularly adapted to create and dynamically adapt the grouping and grouping related features or actions according to current network context and configuration and management tasks provided (or input) by said configuration and management applications.

In a particular implementation each policy rule comprises a set of conditions and a set of actions related to said conditions. A condition may comprise a compound expression which is related to one or more entities such as group members, hosts and grouping protocols. An action relates to a set of actions specifying parameters to be input to one or more grouping protocols.

In the present invention a node may comprise a computer, e.g. a PC (Personal Computer), a PDA (Personal Digital Assistant), a node of a mobile telecommunications network, for example of a radio access network, e.g. a Radio Base Station (RBS), an RNC (Radio Network Controller) or any other node of the radio network or a node of a core network. It may also comprise any node of a data communications network or generally a Network Element (NE) or some kind of a managed node.

Particularly, in an advantageous implementation, the method comprises the steps of; providing the active grouping related policies to be used for grouping purposes to a policy decision means of the policy engine of a node; monitoring in monitoring means provided in the node, current status and/or change related information of said nodes, group and network; providing said current status and/or change related information to the policy decision means; interpreting the grouping policies with respect to current status and/or activity related information; making grouping related decisions based on said interpretations; enforcing the decisions made by means of the grouping protocol interacting with the communication layer to enable interaction and communication with other nodes. Other preferred or advantageous, optional, features may be implemented in any desired manner, also with respect to the inventive method.

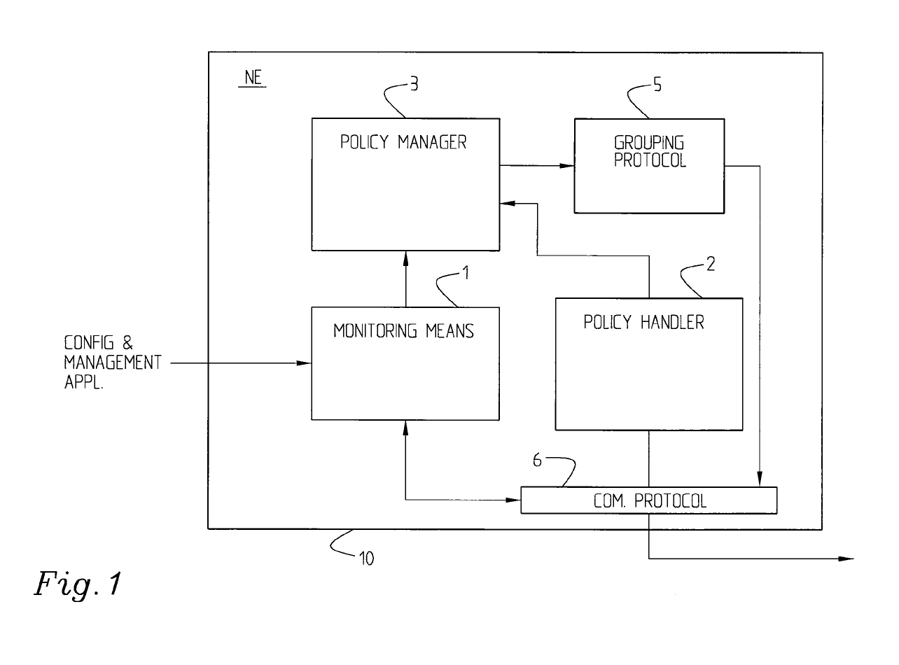

FIG. 1 schematically illustrates a node or a Network Element NE 10 in which the inventive concept is implemented. The node 10 additionally comprises any other conventional means needed for performing the task of the node in question, which means are not shown herein since the node actually may relate to any kind of node as discussed above. According to one implementation of the inventive concept the node comprises monitoring means 1 comprising a monitoring component or manager tracking the state and changes in the network as well as the activity and status of both the group and node members, i.e. it collects or establishes current or up-to-date information. Alternatively it establishes (detects) or collects changes. The information is then reported to a policy manager 3 acting as a Policy Decision Point (PDP) and being adapted to interpret the policies as provided from a policy handler 2 concerning the group formation strategy. The purpose is to guide the decision making process (concerning for example the membership of nodes, the structure of the group, the constraints, and metrics used) to meet the specific objectives of the relevant network-configuration and management task/application. In this figure the policy handler 2 is very schematically illustrated. It may collect policies and activate them in any appropriate manner or it may comprise a user interface for indication and/or activation of relevant grouping policies, which then are provided to the policy manager 3. The policy manager 3 comprises means for interpreting active policies in the light of current node, group and network related information for making appropriate decisions. The policy manager 3 also comprises enforcement means adapted to enforce the policy decisions made by the decision function of the policy manager 3 by cooperating with the group management protocol 5, which in turns interacts with the communication layer of the communication protocol 6. The communication layer provides all messaging utilities necessary for interaction with other group members and to control the group structure.

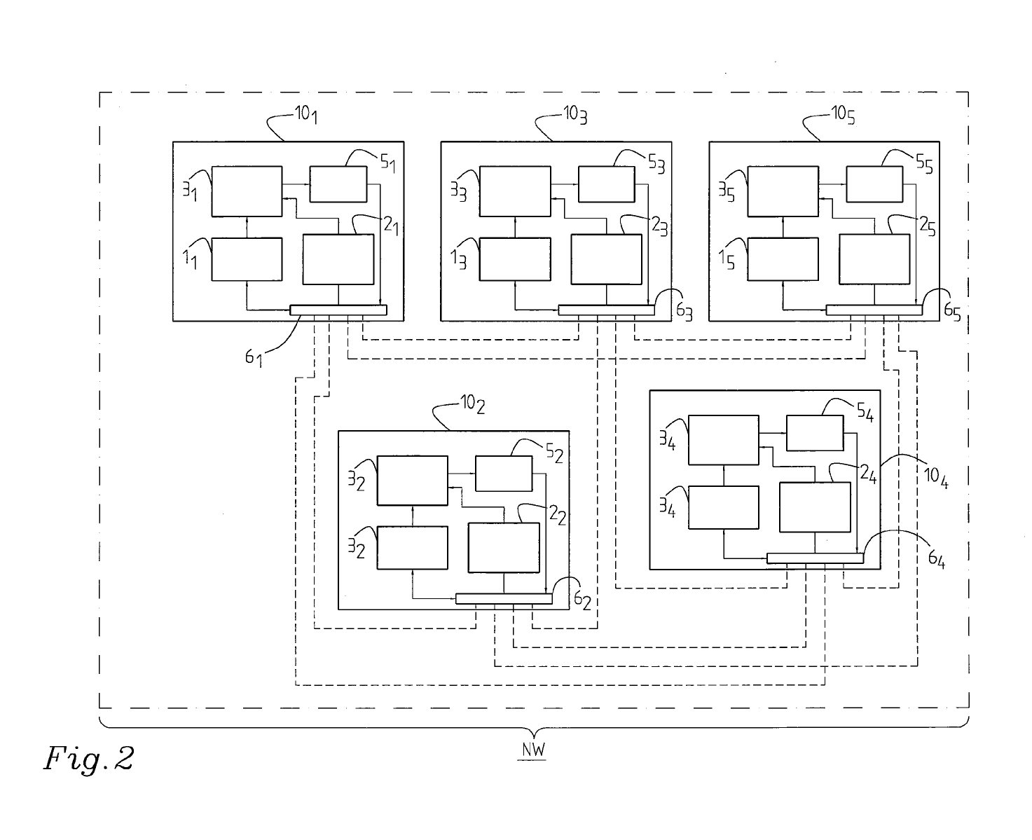

FIG. 2 very schematically illustrates a network comprising a number of nodes 10₁, 10₂, 10₃, 10₄, 10₅ including a functionality as described with reference to FIG. 1. It is here supposed that a group 61 is formed consisting of nodes 10₁, 10₂, 10₃. Using grouping policies as described above, the nodes will be self-grouping for management. In one embodiment the nodes can be grouped in a tree-like manner providing a basic structure for aggregating messages relating to faults that occur on nodes or network elements. Such a grouping reduces the operation and maintenance traffic significantly and therefore increases the management efficiency of the network. Of course nodes can be grouped in other manners, or more generally in any appropriate manner. The groups are formed automatically and they are adapted for configuration and management purposes. It should be clear that a group can have any structure with different features which vary over time; FIG. 2 is merely taken to very schematically illustrate a network comprising a number of nodes in which the inventive concept is implemented and wherein, currently, a group is formed. Node, group related information and network related information is provided between all nodes irrespectively of whether they currently are group members or not. This is one of the factors enabling the dynamical and automatical forming of groups.

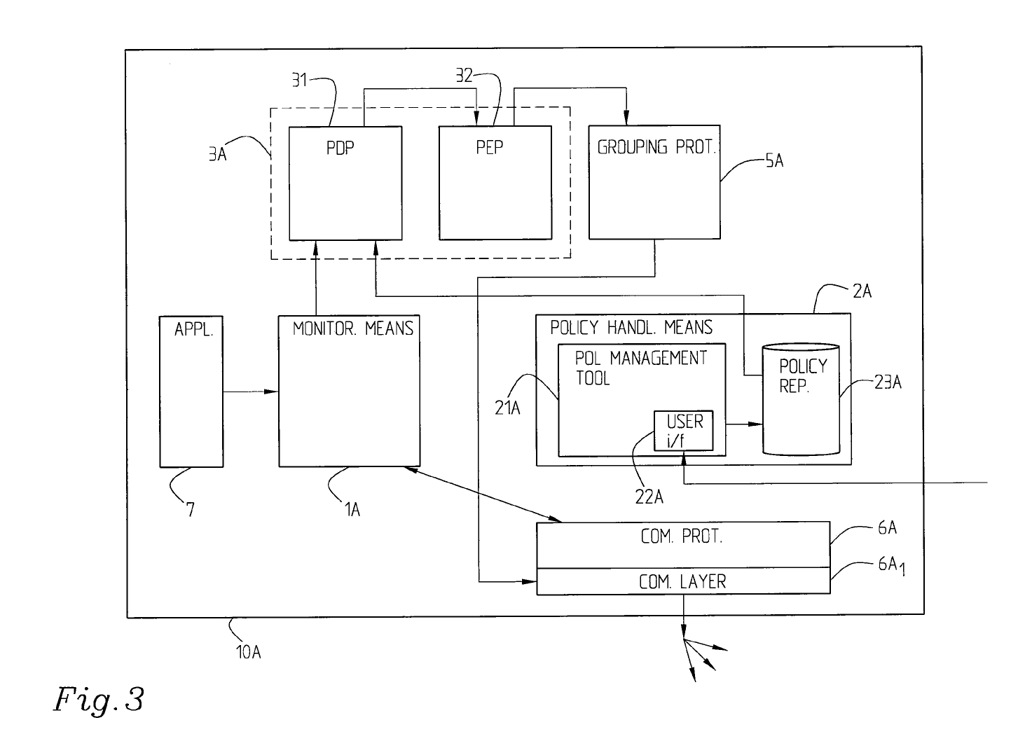

FIG. 3 shows a specific embodiment of a node 10A according to the present invention. As in FIG. 1 the node comprise a monitoring means 1A. The monitoring means here comprise a monitoring component or a manager establishing or tracking the state and changes in the network as well as the activity and status of both group and node members. The monitoring means 1A are adapted to report said established current and activity related information to a policy decision point PDP 31 of a policy managing means 3A. The PDP 31 is adapted to interpret the active policies (see below) concerning group formation strategy, so as to guide the decision making process, as discussed above, to answer to the specific objectives of a network configuration and management task/application 7, which in FIG. 3 is illustrated as being incorporated in the node 10A. Via a user interface 22A of a policy management tool 21A of policy handling means 2A, a network administrator or similar may indicate or input grouping policies that are to be used for grouping purposes by means of a user interface. In this case the policy handling means 2A also comprise a policy repository 23A from where the applicable grouping policies upon indication via user interface 22A can be activated or indicated and provided to the PDP 31 as discussed above. Thus, PDP 31 is provided with the current or up-to-date (and/or change related) information from the monitoring means 1A and with the relevant active policies from the policy handling means 2A, in this case particularly from the policy repository 23A. PDP 31 is adapted to make decisions based on the active grouping policies and with regard to the current situation or network context or the configuration and management tasks to be performed according to application 7. When decisions have been made in PDP 31, they also have to be enforced. Therefore information about the decisions made is provided to a policy enforcement point PEP 32 which is responsible for enforcing the policy decisions made by the PDP 31. PEP 32 enforces the decisions by cooperating with the grouping or group management protocol 5A which interacts with the communication layer 6A of the communication protocol, thus allowing interaction and messaging with the other group members and allowing for group structure control. Actually the PDP 32 gives order or orders to the grouping protocol which interacts with the communication layer 6A₁.

In a particular implementation the node comprises a policy conflict resolution function, advantageously implemented in the policy manager 3A, particularly PDP 31, which is adapted to detect conflicts between e.g. contradicting or overlapping policies, for example to prevent the system from any unpredictable or faulty grouping behaviour.

A policy particularly guides the grouping behaviour and regulates how the group is structured through high-level declarative directives corresponding to rules. Each policy rule particularly comprises a set of conditions and a set of related actions. Policy rules are in the form of if “condition” then “action”. The “condition” expression may be a compound expression relating to entities such as group members, hosts or grouping protocols. The “action” expression may relate to a set of actions that specify for example parameters to be input or provided to one or more grouping protocols.

According to the actions given by the policy engine, particularly the policy managing means 3, 3A or more generally the policy engine here comprising this manager, (PDP 31, PEP 32), policy handler 2 or policy handling means 2A (with policy management tool 21A and policy repository 23A) and monitoring means 1A, the grouping protocol can adapt the grouping structure dynamically, substantially without requiring any human intervention at all. Particularly the monitoring means (e.g. 1;1A;1B) do not have to be included in the policy engine, but may consist of separate means.

If a conflict resolution procedure is implemented, the node 10; 10A particularly comprises a conflict detection function which is adapted to verify that policies do not contradict each other. A policy conflict resolution procedure may be automatically invoked when a conflict has been detected, or by means of some kind of intervention when a conflict has been detected and indicated. It may either be done automatically or operator controlled. In some embodiments the intervention of a network administrator may be mandatory to determine which policy is to be used in case two or more policies contradict each other or overlap etc.

Alternatively a conflict is regulated automatically by means of a predetermined scheme where different policies are given different priorities and then only if two (or more) policies have the same priority human intervention is required. It is of course also possible to provide for automatic selection of a policy to be active according to some predefined criteria, (e.g. depending on which policy was activated first, which policy concerns the largest number of entities or arbitrarily, randomly etc.), even when the priority is the same.

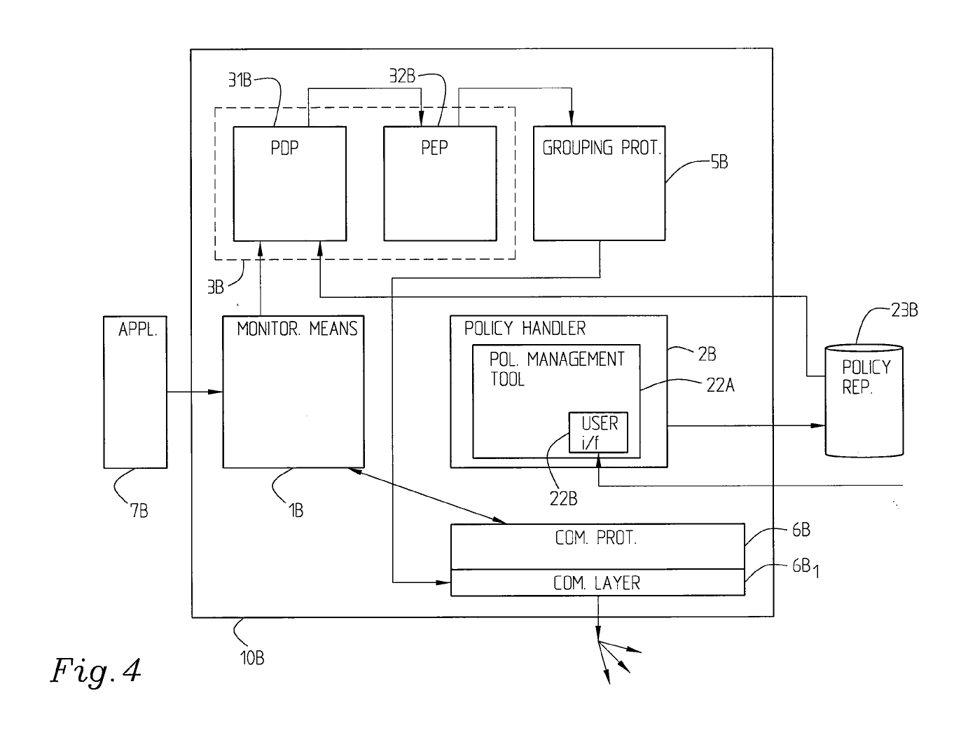

FIG. 4 schematically illustrates an alternative implementation of a node or a network element 10B in which the inventive concept is implemented. As in FIG. 3 the node comprises monitoring means 1B, a policy handling means 2B comprising a policy management tool with a user interface 22B, policy managing means 3B with a PDP 31B and a PEP 32B as in FIG. 3. Further the node comprises or supports a grouping protocol 5B interacting with the communication protocol 6B communication layer 6B₁ as in FIG. 3. However, in this case a policy repository 3B is provided externally of the node but in communication with the policy management tool 21B, or more generally with the policy handler 2B. In such an implementation relevant grouping policies are provided or communicated to, or fetched from the policy repository 23B by the policy handler 2B or by the policy management tool 21B and forwarded to, the PDP 31B. Generally the policies may be provided for in any appropriate manner. A configuration and management application is here shown as being provided externally of node 10B.

It should be clear that of course embodiments are also covered wherein the applications reside within the node. In a similar manner, a policy repository or similar may be outside the node or inside the node, but not related to, or related to, the applications residing in the node. In this case, hence, the policy engine includes the policy managing means 3B, the monitoring means 1B and the policy handling means 2B, whereas in FIG. 3 the policy engine is considered also to include a policy repository.

Below some examples of policies for group formation are given. It should be clear that the examples are given purely for exemplifying, non-limiting, purposes and they should in no way be interpreted in a restrictive manner, i.e. many other policies concerned with group formation or features thereof can be used, either separately or in combination.

Hence, as a first example there may be a policy based on the role and logical hierarchy of the network elements which policy is defined to group all, here, RBSs together and give the leadership of the group to an RNC and further to group neighbouring RNCs. An example of a corresponding rule would be: if the concerned node is an RBS, then notify the nearest RNC and connect to it.

Another policy may be based on geography for grouping network elements according to geographical proximity or similar. Still further a grouping policy may be based on application level so as to group nodes or network elements according to shared interests, or shared information, or one or more common functionalities.

Still another example is a policy relating to group control, for example defining the maximum number of RBSs that can be lead or controlled by an RNC before splitting the group and sharing the leadership with another RNC.

An example of using these policies could be a grouping structure for a configuration and management task corresponding to tracking and managing the events triggered by some nodes or network elements. For this purpose an efficient grouping structure consists in dynamically organizing the nodes or network elements in a tree-like manner in order to allow the nodes of the tree to perform event aggregation and correlation, and therefore, reduce the traffic generated by the event dissemination. Such a grouping can be achieved as follows: Supposing that a management application subscribes to a particular kind of event, the requirement is triggered by the monitoring manager and redirected to the policy decision point. The policy decision point takes into account the role of the local host, for example an RNC or an RBS, and assigns the local node a position in a given level of the tree. The considered number of possible children that are selected depends on the location of the network element or node. After receiving the decision made by the PDP, the PEP enforces it by giving the information in a comprehensive way to the protocol that implements it, i.e. structure the members in a tree-like manner. It should be clear that this merely is an example among many others intended to show how the inventive concept can be implemented.

According to defined or activated policies nodes may, according to the inventive concept, permanently or temporarily organize themselves into groups based on for example the metric or metrics driven by the configuration and management tasks that are to be performed. Therefore, despite a large network size and a large network complexity, many aspects of network management can be automated through a policy based system as discussed above providing an explicit organization of the network used as a basis for performing management tasks.

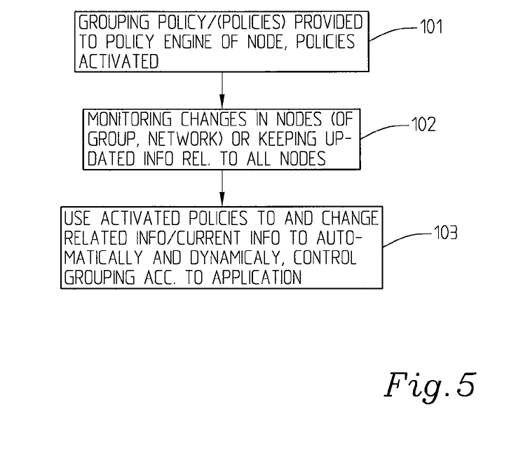

FIG. 5 very schematically illustrates a flow diagram intended to describe the main steps of the inventive concept. It is assumed that one or more grouping policies is/are provided to a policy engine of a node and that these policies somehow are activated, 101. The provisioning and the activation of the policies can be carried out in two separate steps or in one step and the provisioning as well as the activation of policies can take place in many different ways, the most important being that one or more policies which concern grouping are provided to a node. Also other nodes in the network are presupposed to support the same concept and hence also comprise what is called a policy engine as exemplified in FIGS. 1, 3 and 4 above.

It is also supposed that more or less in parallel with the provisioning and activation of grouping policies, changes in nodes, in the group and in the network, as well as group characteristics are monitored by monitoring means of the policy engine (alternatively it keeps or collects updated information relating to all nodes implementing the concept), 102. Also the monitoring can take place in different ways, either by continuously monitoring state etc., or by performing the monitoring at discrete steps, or by providing for the ability to detect changes in general or changes of a number of predefined types.

In the policy engine of a node, the activated policies in view of the change related information or current information are used to automatically and dynamically control grouping according to a relevant application, 103.

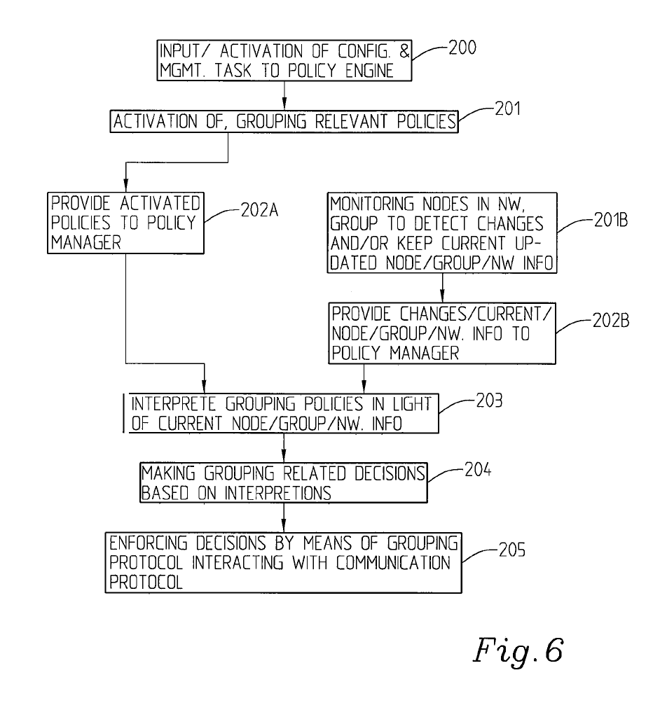

FIG. 6 is a flow diagram describing an exemplary procedure of the inventive concept. It is supposed that a configuration and management task is input or provided to a policy engine of a node, 200. In the node relevant grouping policies are activated in any appropriate manner as discussed above, 201. The activated policies are provided to the policy manager, 202A. The policy engine monitors nodes, the network, the group to detect changes and/or to keep current updated node, group and network information, 201B. The monitoring procedure may be performed in many different ways, continuously, at discrete occasions or at predetermined occasions. Reporting may also be done to the monitoring means at the occurrence of certain events, changes etc. The changes or the current information of the group node, group and/or network are/is provided to a policy manager of the policy engine in the node, 202B. Using the information provided in steps 202A and 202B respectively concerning grouping policies and changes or current node information etc., the grouping policies are interpreted in the light of current node/group/network information, 203. The policy manager of the policy engine then makes grouping related decisions based on said interpretations, 204. By means of a grouping protocol interacting with the communications protocol implemented in the network, the decisions are enforced, 205.

In one implementation a policy administrator is responsible for keeping the policies that are used by the group members up-to-date. The policy administrator may then use the policy management tool, cf. FIG. 4. It should be noted that the policy administrator may use any policy management tool deployed on the group members. In a particular implementation the policy management tool provides a graphical interface allowing the policy administrator to easily specify, change, and delete the policies that are used in the overall group and a distribution functionality in charge of propagating the policy updates to the rest of the group. It should be clear that the policy management tool may be of many different kinds. For example, as an alternative to a graphical interface, it may comprise an audio interface or a combined interface or any appropriate automatic interface etc.

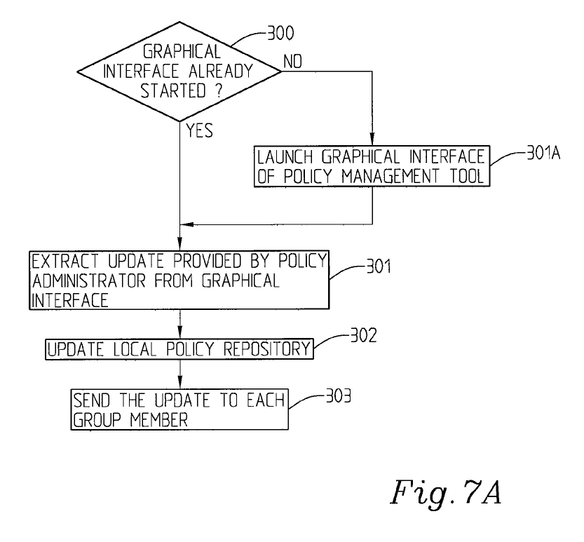

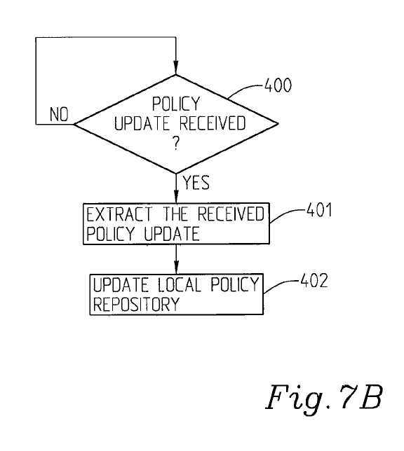

FIG. 7A shows one example of the process of updating a policy. First of all, the administrator launches a (here) graphical interface which is included in the policy management tool. If the graphical interface is already running on the administrator's terminal, there is no need to run another instance of the graphical interface, i.e. it is established if the graphical interface is already started, 300. If not, the graphical interface of the policy management tool is launched, 301A. Then, and if the graphical interface already was started, the updates provided by the policy administrator are extracted from the graphical interface, 301, and the local policy repository is updated, 302. Thus, using the graphical interface, the policy administrator updates the policies that in addition are stored in (here) the local policy repository. Then the update or updates are sent to each group member, 303, i.e. the updates are distributed to all members of the group by the policy management tool as illustrated in FIG. 7B.

Upon reception of such an update, the policy management tool deployed on the receiver updates the policies included in its local policy repository, i.e. it is established if a policy update is received, 400. If yes, the received policy is extracted, 401, and the local policy repository is updated, 402.

It should be clear that the invention is not limited to the specific, illustrated embodiments but can be varied in a number of ways within the scope of the appended claims.

1. A node supporting networking and communication with other nodes by means of a layered communication protocol comprising a communication layer and further supporting group communication with other nodes controlled via a grouping protocol adapted to interact with said communication layer, the node comprising a policy engine which is arranged separately from, but in communication with, said grouping protocol, said policy engine being adapted to establish current and/or changing node, group and network related information, and to use said information and one or more indicated or activated grouping policies to automatically and dynamically control grouping related actions and adapt the grouping.

2. A node according to claim 1, wherein said policy engine comprises or communicates with monitoring means adapted to collect said current and/or change related information concerning status and/or activity of nodes, group(s) and network, said policy engine further comprising a policy decision means, said monitoring means being adapted to provide said information to the policy decision means and a policy handling means adapted to indicate and/or activate one or more grouping policies to be used in node grouping and further being adapted to provide information about said one or more grouping policies to the policy decision means, the policy decision means being adapted to interpret said active grouping policies and to make grouping related policy decisions based on said interpretations, and policy enforcement means adapted to enforce said decisions.

3. A node according to claim 1, comprising policy enforcement means, wherein said policy enforcement means are adapted to enforce decisions using the grouping protocol interacting with the communication layer of the communication protocol.

4. A node according to claim 2, wherein the policy handling means comprises a policy management tool with a user interface.

5. A node according to claim 2, wherein the policy handling means comprises or communicates with policy handling means holding policies related to grouping.

6. A node according to claim 2, wherein the policy decision means are adapted to control a grouping related decision process relating to one or more of group membership of nodes, group structure, group or group member constraints, and metrics.

7. A node according to claim 2, wherein the grouping protocol comprises a group management protocol providing messaging capabilities required for group controlling and node group member communication.

8. A node according to claim 2, wherein the policy enforcement means are adapted to control the grouping protocol, said control corresponding to the decisions made in the policy decision means.

9. A node according to claim 1, wherein the grouping policies are defined as respective sets of policy rules.

10. A node according to claim 9, wherein the policy decision means comprise a policy conflict resolution function adapted to detect conflicts between policy rules of different active policies and to resolve the conflicts automatically or by means of invoking manual intervention.

11. A node according to claim 2, wherein the node is adapted to comprise or communicate with configuration and management applications and wherein the policy engine is adapted to create and dynamically adapt the grouping and grouping related features according to current network context and configuration and management tasks provided by said configuration and management applications.

12. A node according to claim 9, wherein each policy rule comprises a set of conditions and a set of actions related to said conditions.

13. A node according to claim 12, wherein a condition comprises a compound expression which is related to one or more entities and wherein an action relates to a set of actions specifying parameters to be input to one or more grouping protocol(s).

14. A node according to claim 2, comprising a computer, a PC, a PDA, and a node of a mobile telecommunications network.

15. A data or telecommunications network, comprising a number of nodes according to claim 1.

16. A method of controlling grouping of nodes supporting communication and networking with other nodes by means of a layered communication protocol, comprising a communication layer, and a grouping protocol, the method comprising the steps of:
providing one or more grouping related policies to a policy engine;
monitoring or establishing, in each node, current and/or changing node, group and network related information; and
using said grouping related policies to automatically and dynamically control grouping related actions and adapt the grouping.

17. A method according to claim 16, wherein the policy providing step in a node comprises:
providing the grouping related policies to a policy decision means of the policy engine;
monitoring in monitoring means, in the node, current status and/or change related information in said nodes, the group and the network;
providing said current status and/or change related information to the policy decision means;
interpreting the grouping related policies with respect to current status and/or activity related information;
making grouping related decisions based on said interpretations; and
enforcing the decisions made by means of the grouping protocol interacting with the communication layer enabling interaction and communication with other nodes.

18. A method according to claim 17, wherein the policy providing step comprises:
indicating or selecting, via a user interface, grouping policies to be activated, said policies being available in a local policy repository of the node.

19. A method according to claim 16, comprising the steps of:
detecting, manually or automatically, conflicts or contradictions between different active grouping policies; and
resolving said conflicts manually or automatically.

20. A method according to claim 16, comprising the step of:
providing configuration and management related tasks to the policy decision means of a node from a configuration and management application to initiate a grouping control procedure.
